(19) United States
(12) Patent Application Publication
(10) Pub. No.: US 2022/0198864 A1
(43) Pub. Date: Jun. 23, 2022

(54) Method for protecting voter privacy in an open source transparent ballot recording system

(71) Applicant: David Wei Ge, Kirkland, WA (US)

(72) Inventor: David Wei Ge, Kirkland, WA (US)

(21) Appl. No.: 17/128,114

(22) Filed: Dec. 20, 2020

(51) Int. Cl. G07C 13/00; G06Q 50/26

(52) U.S. Cl. CPC G07C 13/00; G06Q 2230/00; G06Q 50/265

(57) ABSTRACT

A method for creating a process of building a robust open source and transparent ballot processing computer system by using distributed and de-centralized ballot recording, by preventing unqualified persons from submitting ballots, by preventing a voter from voting more than once, by allowing a voter to review and change a ballot previously submitted by the voter, by blocking the public from tracing a ballot to a voter, by protecting voter's voting rights from stolen voter identity, by providing processes for processing paper ballots by machines, by providing processes for handling mail-in ballots, by providing processes for online voting.

### TECHNICAL FIELD

Embodiments of the present invention relate to field of computer software engineering. In particular, embodiments of this invention relate to making a ballot recording software. In particular, embodiments of this invention relate to making a ballot recording system which is transparent to the public and thus can be trusted by the voters. In particular, embodiments of this invention relate to transparent ballot counting system, for example, a ballot counting system using distributed and de-centralized recording method to gain voter trust, or using a method similar to the distributed computing technologies used by the digit-currencies, such as the block chain technology used by the bitcoin. The many years of success of the digit-currencies prove that such a distributed and de-centralized book keeping is feasible and reliable. In particular, processes of the embodiments of the present invention solve major problems which prevent a transparent ballot counting system from being successfully used.

### BACKGROUND ART

Voting by everyone is one basic characteristics of democratic politics. When the number of voters is large, counting the ballots becomes a daunting task. In many cases, the results of the ballot counting have been questioned. Nowadays most ballot counting is done involving computers. But the reliability of the ballot-counting by computers is more questionable than manual ballot-counting.

Before computers are used in ballot recording, voters had to trust those persons who were doing the counting of the ballots. This situation has not changed when computers are used to record ballots. Actually it makes the situation worse. The computers are controlled by software. The software is made by human. The persons who make the voting software can carry out vote fraud with such an efficiency not possible by human ballot counters. Such possibility becomes a major reason for losing candidates and their supporters to raise accusations of vote fraud. Such possibility is also a major difficulty for wining candidates to defend their innocence and gain full trust of voters.

### SUMMARY OF INVENTION

### Technical Problem

Problem 1—transparency of the ballot-counting. Most current ballot recording systems use centralized recording systems. It is all too easy for the software engineers who created the recording system to manipulate the voting results. Various monitoring measures may be used, but it is not possible to get a totally transparent voting system out of a centralized system. Therefore, voters will always doubt about voting fraud. This is especially true when the number of the ballots are large. In many cases, losing candidates and their supporters would accuse the opponents for manipulating the voting system. On the other hand, the winning candidates are in a hard situation to defend their innocence.

The digit currencies prove that a transparent and completely trusted book-keeping is possible.

The digit currencies use the distributed computing to achieve book-keeping transparency. But applying the digit-currency technologies to ballot-counting brings following problems.

Problem 2—voter qualification and identification. Everyone can own a digit-currency, but not everyone can vote. Therefore, unlike a digit-currency, a voter must register and be identifiable. The voter also wants to know his/her ballot is counted correctly, that is, the voter wants to be able to identify his/her ballot in the balloting counting system.

Problem 3—voter privacy. Even though the voter must be identifiable, the voting cast of a voter must be kept secret from the public. This is a conflict with Problem 2.

Problem 4—ballot uniqueness. The system must identify a voter and make sure that a voter can only vote once. This is a conflict with Problem 3.

Problem 5—voter account recoverability. A user must have an account to own digit-currency. It causes a big problem for a voting system. For a digit-currency, owner privacy is achieved by abandoning the account recoverability. If you forget your credential to access your digit-currency account then you lose whatever you hold in your account, be it worth one dollar or 100 million dollars. But a voter cannot lose her/his voting rights forever just because she/he forgets her/his password to her/his voter account. To make the situation more complicated, there is a possibility that someone else knows a voter account's password instead of the voter himself/herself. This situation may happen when someone knows another person's ID and uses it to create a voter account.

Problem 6—Network connectivity. Distributed computing requires network connectivity. In some places and for some voters, network connectivity may not be available.

The above problems tangled together in conflicting ways. Solving one problem individually is one matter. But solving all of them simultaneously becomes a challenge. Not only to solve the problems simultaneously, the solution must be robust to system failures, software bugs, and network connection failures; that is, a failed operation will not cause unrecoverable damages, and an operation can always be tried again.

### Solution to Problem

The solution of the ballot-counting problem provided by this invention is to provide robust solutions simultaneously to all the problems listed previously. The solution to one problem do not affect the solutions of the other problems. The solutions do not fall apart due to system failures, software bugs, and network connection failures. The solution provided by this invention does not rely on any secret keys to protect voter privacy, it is a truly transparent system; thus the solution provided by this invention can be implemented by open source software and thus trusted by the voters and the public.

In the descriptions and claims of the solution provided by the present invention, a term “database” refers to a collection of data; for example, one or more tables in a relational database can be referred to as one “database”. A term “record” refers to a collection of data belonging to a “database” and uniquely identifiable by a unique ID; for example, a record in a table of a relational database can be referred to as a “record”.

Solving of Problem 1 of ballot counting transparency is stated below.

The embodiments of the present invention provide processes for building a complete open source transparent ballot recording system using distributed computing. The embodiments of the present invention provide processes for doing ballot recording at the same time on multiple participating computers owned by different organizations and individual voters. All participating computers are identical in the ballot recording software and the related databases, making vote fraud impossible.

The embodiments of the present invention provide processes for validating ballots by all participating computers. When a ballot recording request for one or more ballots is invoked by a participating computer, the request is logged and validated by all participating computers. If any participating computer rejects the request then an investigation on the invoking computer may be trigged depending on the nature of the rejection. If all participating computers pass the validation of the request then the ballots can be counted in the vote statistics.

The embodiments of present invention provide processes for setting up voting rules to be enforced by all the participating computers. Examples of such voting rules can be that for each voting item, one voter may only vote once.

The embodiments of present invention provide processes for validating all database writing and modifications by all participating computers; all database writing and modifications must be performed by all the participating computers in the similar way like the block chain scheme used by digit-currencies. Thus, critical databases in all participating computers are identical, not including temporary data for enhancing software execution performance.

Solving of Problem 2 of voter qualification is stated below.

The embodiments of the present invention provide processes for creating a voter registration database (VRD) from an official voter registration system; an example of said official voter registration system can be a county government voter registration system. Every voter registration record in the said VRD uses a unique ID to identify the voter registration record; the said unique ID is referred to as the voter ID. The said voter ID uniquely identifies a voter; the voter ID can be a unique personal ID copied from the official voter registration system; it can be the social security number, driver's license or other personal ID which the official voter registration system uses to uniquely identify each voter. The said voter ID can also be a new unique ID created from a one-to-one mapping of an existing personal ID from the official voter registration system. The said voter ID can also be a newly created unique ID not mathematically linked to any existing personal ID; in this case, a voter registration record is linked to one and only one official resisted voter via a personal ID or a database record ID. Except for the voter ID, the said VRD does not contain voter personal information which may raise privacy concerns. Said VRD is used for solving the problem of voter qualifications; all voter qualification information is kept in VRD or linked to VRD, and can be retrieved from VRD via the voter ID.

Solving of Problem 3 of voter privacy is stated below.

The embodiments of the present invention provide processes for creating a voter account database (VAD). The said VAD uses a unique account ID for each account record. Each of said account record is owned by one voter; a hash of the account owner created password is saved in the account record; an encryption of the owner's voter ID is saved in the account record; the encryption key can be the user password. By using two separate databases, one database is said VRD and the other database is said VAD, and by using an encrypted voter ID to link the two databases, the voter qualification problem and the voter privacy problem are solved simultaneously.

The embodiments of the present invention provide processes for creating a ballot recording database (BRD) and an election database. Said election database uses a unique ID referred to as the election ID to identify an election. The said BRD records each ballot a voter submitted; complete ballot information, including election ID and vote casts, is recorded together with the voter account ID. Because the voter ID and the personal information of the voter cannot be identified by the voter account ID, the public cannot trace a vote cast to a specific voter. On the other hand, the voter can log in to his/her voter account to view his/her vote cast and change his/her voting. Thus the voter identification problem and the voter privacy problem are solved simultaneously.

Solving of Problem 4 of ballot uniqueness is stated below.

The embodiments of the present invention provide processes for preventing from voting more than once by one voter; a voter logs into her/his voter account using the account ID and the password; said processes use the password as the key to decrypt the encrypted voter ID. The voter ID is used to identify the voter in said VRD. A ballot submission database (BSD) links a voter ID with an election ID to indicate whether a ballot has been submitted by a voter for an election. Said BRD saves ballots with an account ID associated with each ballot. Said VRD verifies the voter qualification; for example, if the voter has moved out of the current election region then the voter is disqualified. Said BSD verifies whether or not for an election there is a ballot submitted already. If there is a ballot submitted by the voter ID and the voter's account ID is not among the submitted ballots then the voter is not allowed to submit her/his ballot. If the voter's account ID is among the submitted ballots then the voter is allowed to replace previous ballots, depending on the election policies.

In the processes of the present invention, even a personal ID is used as the voter ID, what the public may know is whether or not a person submitted her/his ballot, but the public does not know the cast of her/his vote. Thus, Problem 4 is solved without compromise the solutions for Problem 2 and Problem 3.

Solving of Problem 5 of voter account recoverability is stated below.

The embodiments of the present invention provide processes for recovering voter accounts in three methods: method 1, method 2 and method 3.

The said method 1 provides processes for handling the case when a voter forgets her/his voter account ID or password; said processes let the voter re-create a voter account record in said VAD using her/his voter ID; the voter provides her/his voter ID and a new password; a new record is created in said VAD with a new unique account ID. The above processes are designed to be used when a voter forgets her/his account ID or password. To prevent malicious abuse of the above processes, some policies can be implemented; for example, limiting the number of account re-creations in a certain amount of time; requiring that the voter goes to official physical locations for in-person voter identity verifications before re-creating a voter account, etc.

Said method 2 provides processes for handling the case when a voter account is not owned by its true owner of the voter ID; for example, person A knows the voter ID of person B, person A uses person B′s voter ID to create a voter account; if person A submits a ballot before person B does then person B cannot submit her/his ballot, and person B will know her/his voter ID is stolen; said processes of said method 2 require person B to report the voter ID stolen case, for example, go to the official voter registration office to report the voter ID stolen case; the official voter registration office verifies the case and mark the voter ID to be invalid in said VRD; the official voter registration office creates a new unique voter ID for the voter; the new voter ID is linked to the voter record in the official voter registration system; there is not a link between the old voter ID and the new voter ID in said VRD; the voter uses the new voter ID to create a new voter account record in said VAD; during a voter account log in process, the voter provides the account ID and password; the password is used as a key to decrypt the encrypted voter ID; the voter ID is used to locate the voter registration record in said VRD; if the voter registration record is marked as invalid then it is identified that a stolen voter ID is being used, clues will be gathered to help crime investigations.

The said method 3 provides processes for handling the case when a large number of voter ID's are reported stolen at the same time; the said processes of method 3 increase the value of a flag by 1 for all the voter registration records reported voter ID stolen; the said flag initially is 0; each of all the voters reported voter ID stolen should create a new voter account record in the said VAD using her/his voter ID; the said flag value is also saved in the new voter account record; during a voter account log in process, the voter provides the account ID and the password; if the account ID and the password hash match then the flag saved in the voter account record is compared to the flag saved in said VRD record identified by the voter ID which is decrypted using the password as the encryption key; the log in is successful only if the flag saved in the voter account record and the flag saved in the voter registration record match. Thus, the voter account records with stolen voter ID's are disabled. When such accounts are used clues can be gathered to help in crime investigations.

Database trimming policies can also be implemented. For example, periodically, the voter account records can be deleted for those records which have not been logged into for certain amount of time, or for certain times of elections.

Solving of Problem 6 is stated below.

The embodiments of the present invention provide processes for voters without network connectivity to vote. The said processes provide 3 approaches to meet different voter requirements; they are approach 1, approach 2 and approach 3.

The processes of said approach 1 setup vote stations for voters without cell phones and networked computers; in the said vote stations, computers with network connections are provided for the voters to use.

The processes of the said approach 2 print voter ballots on papers for those voters who requested, and their voter ID's are printed on each ballot, the voter ID can be in bar code or in QR code; at a vote station, a voter feeds her/his ballot into a ballot processing machine; said ballot processing machine reads the ballot and uses the voter ID code to create a temporary voter account with a randomly generated password, and mark the account as being machine created and being a temporary account, if said VRD indicates that there is not a manually created voter account created for the voter ID; the said ballot processing machine submits the ballot using the said temporary voter account; the said ballot processing machine prints the voter account ID and the password for the temporary account for the voter; the voter may later use the voter account ID and the password to submit ballot-replacement; when a voter feeds the said ballot processing machine a ballot the second time, the system detects that the voter has already submitted a ballot; the said machine prompts the voter for a voter account ID and password; the voter enters the voter account ID and the password; the machine starts the process of replacing the previously submitted ballot if the correct account ID and password are entered.

The processes of said approach 3 print voter ballots on papers for those voters who requested, and their voter ID's are printed on each ballot in bar code or in QR code; the ballots are mailed to the voters; the voters make their vote cast on the paper ballots and mail their ballots back to a ballot processing station; at said ballot processing station, official ballot processing personals feed the ballots to said ballot processing machines; said ballot processing machines read the ballots and use the voter ID codes to create temporary voter accounts; the said machines submit the ballots using the said temporary voter accounts.

Advantageous Effects of Invention

By implementing present invention, a transparent ballot-counting can be created while voter privacy is protected. It brings following advantages effects.

It is highly unlikely for any candidate to raise accusation of vote fraud, because if all databases owned by various parties and individuals are identical and all voters can verify that their ballots are counted, and counted correctly, and if all voters are voted anonymously, then no one can say that the vote results have been altered.

If there are databases discrepancies between participating computers then there will be plenty of proofs in all the databases to identify at which computers the voting abnormality occurred. People cannot erase their databases and then claim vote victory. People have to use their databases to prove their vote victory, and those very databases will contain crime evidences, if there are crimes. That is, if there are vote fraud then it is not possible to erase the evidences. Thus, a complete transparent and trusted voting system is achieved.

Voting can be simpler for voters. Voters can use their cell phones to vote and change their votes. Because the voters can verify their vote casts, and because the voters can vote many times without worrying about counting a vote more than once, the voting system is robust to system failures and network failures.

Costs of elections can be much lower than current voting processes. If most voters choose not to use paper ballots then there is not a need of huge number of ballot processing personals, and there is not a need to print large number of ballots.

The current voting processes require large number of monitoring personals to watch and monitor the processing of ballots. By using this invention, even for mail-in ballots processing, there is not a need of monitoring personals.

### BRIEF DESCRIPTION OF DRAWINGS

FIG. 1 Participating Computers. It shows a typical implementation of this invention. It shows 3 participating computers, which form a distributed and de-centralized ballot recording system. The drawing shows that all participating computers are connected to each other. Using the internet as a mean of connection, a large number of participating computers is possible.

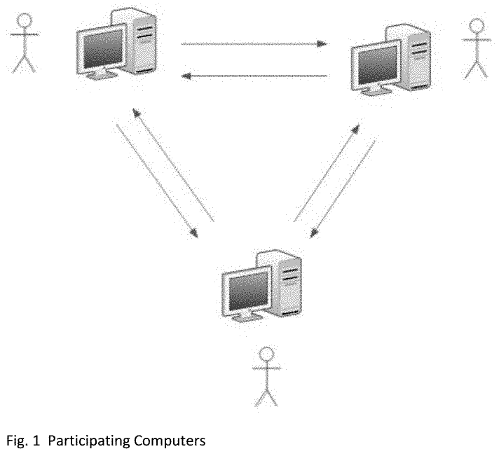

FIG. 2 Ballot Recording Software Structure. It shows a typical process for creating a distributed ballot recording software installed on one participating computer, implemented by the processes provided by this invention. The ballot recording inputs are entered by human, by computers or by ballot-processing machines. The inputs are used by the request-generator to generate ballot-recording requests and insert into a request queue. The requests are sent out to all participating computers. The request-validation module receives the requests from all participating computers and make validations using vote-rules. The validation results are logged in the request queue and sent to all participating computers.

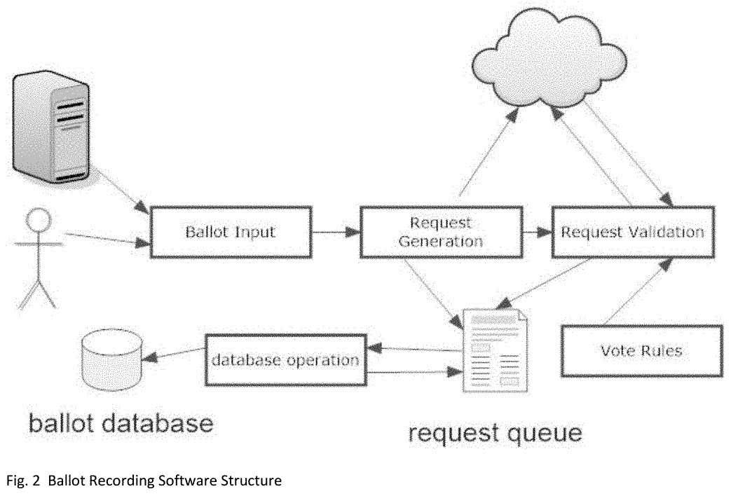

FIG. 3 Databases. It shows a typical data flow between databases used in a distributed ballot recording system. The voter registration database is created from the official voter registration system. A voter creates a voter account in the voter account database. A voter logs in to her/his voter account and submit a ballot. The ballot is validated by all the participating computers and recorded in the ballot recording database.

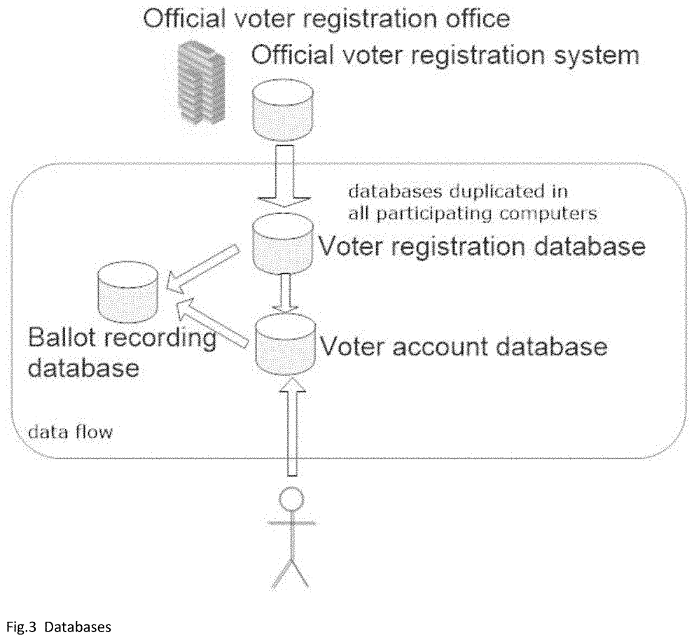

### DESCRIPTION OF EMBODIMENTS

One embodiment of this invention is by creating a distributed and de-centralized ballot recording system. The said distributed ballot recording system consists of a ballot database and a database operation module, a voting-rule module, a ballot request queue, a ballot input module, a request generation module and a request-validation module. The said ballot input module receives one or more ballots to be recorded, from human, from computers or scanned in by a ballot-processing machine. The said request generation module generates a request for these inputs, sends the request to all the participating computers and inserts the request into said ballot request queue as a block chain; said request-validation module validates the ballots in the requests and records the validation results in the ballot database.

One embodiment of this invention is by creating a block chain for all database writing and modifications; said database operation module handles all the database writing and modifications and uses the block chains to ensure that databases in all participating computers are identical.

One embodiment of this invention is by creating a voter registration database from an official voter registration system; an example of the official voter registration system can be a county government voter registration system. Said voter registration database copies voter ID from the official voter registration system. The voter ID uniquely identifies a voter; it can be the social security number or other ID which can be used to uniquely identify a voter; the voter ID can be a unique ID not mathematically linked to a personal ID, and only linked to a personal ID via database linking. The voter ID uniquely identifies a voter registration record in said voter registration database. Said voter registration database does not record voter personal information which may involve privacy concerns. Said voter registration record contains a mark indicating whether or not the voter ID is disabled or invalid. Said voter registration record contains a flag for detecting stolen voter ID. Said voter registration database contains marks indicating whether or not a ballot is submitted for an election by a specific voter. Said voter registration database contains marks indicating whether a valid voter account has been created.

One embodiment of this invention is by creating a voter account database. Said voter account database uses a unique account ID for each account record. Each of said account record is owned by one voter; a hash of a password created by the account owner is saved in the account record; an encryption of the account owner's voter ID is saved in the account record; the account record contains a flag for detecting stolen voter ID; the account record contains a mark indicating whether the account record is created by a ballot-processing machine or by a human.

One embodiment of this invention is by creating a ballot recording database. Said ballot recording database records each ballot a voter submitted; complete ballot information, including the voter's vote cast, is recorded together with the voter account ID.

One embodiment of this invention is by using a submission database to prevent multiple ballot counting for one voter; a voter logs into her/his voter account using the account ID and the password; the password is used as the encryption key to decrypt voter ID; the voter ID is used to identify the voter registration record in the voter registration database; said voter registration record indicates whether or not the voter ID is disabled; if the voter ID is disabled then the log in is rejected. Said voter registration record contains a flag; the voter account record also contains a flag; if both flags are not equal then the log in is rejected. Said ballot submission database links a voter ID with an election ID to indicate whether or not for an election the voter has submitted her/his ballot; if the voter has already submitted her/his ballot for the election then a new submission is not allowed.

One embodiment of this invention is by allowing a voter to change her/his ballot; on logging into her/his voter account, the voter account ID is used to identify the ballots in the ballot recording database; identified ballots are marked as replaced; a new ballot is submitted.

One embodiment of this invention is by making ballot-processing machines consisting a scanner to read paper ballot, a screen to show information to the voter, an input device for the voter to enter voter ID and other information when needed, and a computer installed with the ballot-counting software made by this invention.

### EXAMPLE 1

Official voter registration Information. The following table lists an example of the official voter registration information maintained by a government office.

| | |
|---|---|
| Unique Record ID | 234567890 |
| Personal ID | 123-45-6789 |
| Name | Jane Doe |
| Sex | F |
| Birth Date | Aug. 21, 1980 |
| Address | 123 Main Street, My City, My State, USA |
| Registration Date | Aug. 21, 2000 |

### EXAMPLE 2

Voter registration database. The following table lists an example of the voter registration database.

| | |
|---|---|
| Voter ID | 123-45-6789 (it is the Personal ID from the official |
| | voter registration system, see Example 1) |
| Disabled | False (it indicates if this record can be used in |
| | voting) |
| Flag | 0 (it is a flag for detecting stolen voter ID) |
| Account Creation | Indicates whether a valid voter account has been |
| | created manually, and other situations |
| Link to elections: | Qualifications for individual elections |
| Election ID 1 | True |
| Election ID 2 | False |

### EXAMPLE 3

Voter registration database. The following table lists an example of the voter registration database. Example 2 and Example 3 show two approaches in generating a voter registration database. There can be other approaches differ in the way how a voter registration database links to the official voter registration system. Only one approach should be used when using a ballot recording system made by this invention.

| | |
|---|---|
| Voter ID | 234567890 (it is the Unique Record ID from the |
| | official voter registration system, see Example 1) |
| Disabled | False (it indicates if this record can be used in |
| | voting) |
| Flag | 0 (it is a flag for detecting stolen voter ID) |
| Account Creation | Indicates whether a valid voter account has been |
| | created manually, and other situations |
| Link to elections: | Qualifications for individual elections |
| Election ID 1 | True |
| Election ID 2 | False |

### EXAMPLE 4

Voter account database. The following table lists an example of the voter account database. A voter uses her/his voter ID and chooses a password to create a voter account record. A unique voter account ID is created. The voter should remember her/his voter account ID, password and voter ID so that (s)he may re-use her/his voter account, for example, to change a submitted ballot.

| | |
|---|---|
| Voter Account ID | This is a unique ID identifying this record |
| Password Hash | This is a hash of the password the voter chooses |
| Voter ID Encryption | This is an encryption of the Voter ID. See Example |
| | 2 and Example 3. The encryption key is the |
| | password the voter chooses. |
| Flag | 0 (it is a flag for detecting stolen voter ID, see |
| | Example 2 and Example 3) |
| Is Temporary | False (it is True if the account is created by a ballot |
| | reading and processing machine) |

### EXAMPLE 5

Ballot Information. The following table lists an example of ballot and vote cast information.

| | |
|---|---|
| Election ID | WA2023 |

| | | |
|---|---|---|
| Election | ID | WAGovernor2023-Inslee |
| Item 1 | Vote | Yes |
| Election | ID | WAGovernor2023-John |
| Item 2 | Vote | No |

### EXAMPLE 6

Ballot submission record. The following table lists an example of recording ballot submission. It is used to prevent multiple ballot submissions by one voter.

| | |
|---|---|
| Voter ID | it is the Voter ID from the voter registration |
| | database, see Example 2 and Example 3 |
| Election ID | It is the Election ID from the Ballot Information. See |
| | Example 5. |
| Submitted | Yes |

### EXAMPLE 7

Ballot Information. The following table lists an example of ballot information. Note that the public cannot trace the ballot back to the voter who submitted the ballot. But the voter who submitted the ballot can examine it and make sure that the ballot is recorded correctly.

| Ballot Submission | This is a unique ID identifying this submission | | |
|---|---|---|---|
| ID | | | |
| Voter Account ID | It is the Voter Account ID from the Voter Account | | |
| | database. See Example 4. | | |
| Election ID | WA2023 | | |
| | Election | ID | WAGovernor2023-Inslee |
| | Item 1 | Vote | Yes |
| | Election | ID | WAGovernor2023-John |
| | Item 2 | Vote | No |

### EXAMPLE 8

Ballot-recording request information. The following table lists information contained in a ballot-recording request.

| Request ID | Abcdefghijk123456789 | | |
|---|---|---|---|
| Invoker ID | Computer1234567890 | | |
| Time | 2028 Jan. 23 13:10:01 | | |
| Ballots | Ballot 1, Ballot 2, . . . It is a list of ballot submissions, | | |
| | see Example 7 | | |
| Validations | Computer 1 | Computer 2 | . . . |
| | result | result | . . . |

### INDUSTRIAL APPLICABILITY

One area of ballot recording is political elections. State, county and city official elections, senator and president elections, etc., all may benefit from this invention. For example, this invention is applied to most counties individually to get reliable vote results at county level. Then the state level is reliable and thus the country level is reliable.

Public policy voting may also benefit from this invention.

Polls is another area that may benefit from this invention.

1. A method for creating a process of protecting voter privacy in a transparent ballot counting system; said process uses two databases to record voter identity, one database is referred to hereafter as a voter registration database (VRD), the other database is referred to hereafter as a voter account database (VAD); said process uses said VRD to link a voter to her/his personal ID; examples of said personal ID can be social security number, driver license, citizen ID, or any other ID which uniquely identifies a person; said process uses said VAD to perform ballot submissions; said process uses a voter ID in said VRD to identify a voter; said process uses a voter account ID in said VAD to identify a voter; said process uses an encrypted voter ID in said VAD to link said VAD to said VRD.

2. The method of claim 1, further comprising of a process used for encrypting and decrypting voter ID; said process creates a voter account record in said VAD using the voter ID and the user password; said process encrypts the voter ID using the user password as the encryption key for encrypting and decrypting the voter ID; said process saves said encrypted voter ID in the voter account record.

3. The method of claim 1, further comprising of a process used for encrypting and decrypting voter ID; said process creates a voter account record in said VAD using the voter ID and the user password; said process creates a hash of the voter ID and saves it in the voter account record; said process prompts a voter to use password and voter ID to log into the voter's voter account.

4. The method of claim 1, further comprising of a process used for verifying voter qualification; said process allows a voter to log into her/his voter account using said account ID and password; on logging in, said process locates her/his account record and fetches the encrypted voter ID saved in the account record; said process uses the password as the key to decrypt the encrypted voter ID; said process uses the voter ID to locate voter qualifications saved in said VRD; if more than one election should be handled then said process uses an election database to record elections or polls for which ballots will be submitted; said process uses an election ID in said election database to identify each election or poll; if only one election is to be handled then the election database and the election ID mentioned in processes of this invention can be omitted; said process saves election related voter qualifications in said VRD or a database linked to said VRD via voter ID.

5. The method of claim 1, further comprising of a process used for preventing a voter from submitting her/his ballot more than once; said process uses a submission database to record a voter ID with an election ID, and marks whether a voter ID has been used to submit a ballot for an election or poll; on submitting a ballot for a voter, said process saves the voter ID and the election ID in said submission database to mark the ballot submission; before submitting a ballot, said process checks in said submission database using the voter ID and the election ID to verify that the voter ID has not been used for the election ID.

6. The method of claim 1, further comprising of a process used for preventing anyone from tracing a ballot to its voter, except its voter; said process uses a ballot recording database to record submitted ballots, each recorded ballot is linked to a voter account ID.

7. The method of claim 6, further comprising of a process used for changing a ballot by a voter; on logging into a voter account, the voter submits a new ballot; said process verifies that there is a ballot previously submitted using the same account ID; said process marks the previously submitted ballot as being replaced; said process re-generates a ballot submission for the new ballot.

8. The method of claim 6, further comprising of a process used for reviewing ballots by a voter; on logging into a voter account by a voter, said process retrieves those ballots linked to the account ID from said ballot recording database, for the voter to review vote casts contained in those ballots.

9. The method of claim 1, further comprising of a process used for recovering a voter's voting right in the case of voter forgetting voter account ID or password; said process marks in said VRD that existing voter accounts for the voter ID being disabled and a new voter account can be created; the voter re-creates a new voter account in said VAD using the voter ID and a new password and get a new voter account ID.

10. The method of claim 1, further comprising of a process used for recovering a voter's voting right in the case of voter ID stolen; said process marks the stolen voter ID as disabled in said VRD; said process re-generates a new unique voter ID for the voter in said VRD; the voter uses the new voter ID to create a new voter account record in said VAD.

11. The method of claim 1, further comprising of a process used for recovering a voter's voting right in the case of a large number of voter ID reported stolen; said process uses a flag in said VRD and in said VAD to disable stolen voter ID; said process increases the value of said flag in said VRD for all the voter ID's reported stolen; said process allows the voters who reported voter ID stolen to re-create their voter accounts in said VAD; said process sets the flag values of the newly created voter accounts to be the same value of the flag of the records in said VRD; said process detects and disables stolen voter accounts at the time when someone tries to log into a voter account and the flag value of the voter account record in said VAD does not match the flag value of the record in said VRD.

12. A method for creating a process of making a trustable ballot counting system by processing paper ballots by a machine; the said machine is hereafter referred to as ballot-processing machine; said process uses a voter registration database (VRD) and voter ID to identify voters and mark voter qualifications; if more than one election should be handled then said process uses an election database to record elections or polls for which ballots will be submitted; said process uses an election ID in said election database to identify each election or poll; if only one election is to be handled then the election database and the election ID in processes of this invention can be omitted; said process uses a submission database to link a voter ID with an election ID, and marks whether a voter ID has been used to submit a ballot for an election or poll; said process uses a voter account database (VAD) and account ID for a voter to submit ballots; said VAD contains an encryption or a hash of the voter ID; said process uses a ballot recording database to record submitted ballots, each recorded ballot is linked to one voter account ID; said VRD contains voter qualification information indicating whether the voter is qualified to vote for certain elections; said process prints a ballot on paper for a voter with the voter ID and the election ID printed on the paper ballot, and sends the ballot to the voter; the voter makes vote cast on the ballot; the voter mails in the ballot to a vote station or takes the ballot to a vote station; in the vote station the voter or a ballot-handling personal feeds the ballot into said ballot-processing machine; said ballot-processing machine scans the ballot; said process uses the voter ID and the election ID printed on the ballot, to verify, via said VRD, that the voter is qualified to vote; said process uses the voter ID and the election ID to verify, via said submission database, that the voter has not submitted a ballot for the election previously; said process uses the voter ID to create a temporary voter account; said process submits the ballot using the temporary voter account ID, the ballot is saved in said ballot recording database and linked with the temporary voter account ID; said process links the voter ID and the election ID in said submission database to indicate that the voter has submitted a ballot.

13. The method of claim 12, further comprising of a process used for preventing said ballot processing machine from processing a paper ballot if the voter requests that his/her ballots not to be processed by a machine; said process marks in said VRD that a machine can or cannot be used to process his/her ballots; on scanning a paper ballot, said ballot processing machine uses the voter ID to check in said VRD to see if machine-processing is allowed.

14. The method of claim 12, further comprising of a process used for paper ballot users to replace their ballots; said ballot-processing machine prints out the temporary voter account ID and a temporary password, said password is also a key for encrypting the voter ID saved in the temporary voter account, for the voter at the first time the voter feeds a ballot into the ballot-processing machine and successfully recorded the ballot in the ballot recording database; when the voter submits a new ballot again, said process detects via said submission database, by the voter ID and the election ID, that the voter already submitted a ballot previously, and said ballot-processing machine prompts the voter for a voter account ID and password; the voter enters said temporary voter account ID and password; said process locates the ballot using the temporary account ID and the election ID, and marks the ballot as being replaced; said ballot-processing machine submits the new ballot.
